(19) United States
(12) Patent Application Publication
(10) Pub. No.: US 2025/0191394 A1
(43) Pub. Date: Jun. 12, 2025

(54) TEXT GENERATION METHOD AND APPARATUS, ELECTRONIC DEVICE, AND STORAGE MEDIUM

(71) Applicants: Beijing Zitiao Network Technology Co., Ltd., Beijing (CN); Lemon Inc., Grand Cayman (KY)

(72) Inventors: Mingfei HAN, Beijing (CN); Linjie YANG, Los Angeles, CA (US); Heng WANG, Los Angeles, CA (US)

(21) Appl. No.: 18/974,344

(22) Filed: Dec. 9, 2024

(30) Foreign Application Priority Data
Dec. 11, 2023 (CN) 202311695859.4

(51) Int. Cl. G06V 20/70; G06V 10/44; G06V 20/40; G10L 15/26

(52) U.S. Cl. CPC G06V 20/70; G06V 10/44; G06V 20/44; G10L 15/26

(57) ABSTRACT

Embodiments of the present disclosure disclose a text generation method and apparatus, an electronic device, and a storage medium. The method includes: extracting events from a video to be processed, and determining target video frames corresponding to the events; extracting frame features of the target video frames, and determining event features based on the frame features; concatenating the event features in an extraction order of corresponding events, to generate a prompt text; and generating, by a first language model, a description text of the video to be processed based on the prompt text. By concatenating the event features in the extraction order of the corresponding events to obtain the prompt text, and inputting the prompt text into the first language model, the first language model can be enabled to perceive content and order of different events in the video, which can improve the text generation effect.

### CROSS-REFERENCE TO RELATED APPLICATION(S)

This application claims priority to Chinese Application No. 202311695859.4 filed Dec. 11, 2023, the disclosure of which is incorporated herein by reference in its entity.

### FIELD

Embodiments of the present disclosure relate to the field of computer technologies, and in particular, to a text generation method and apparatus, an electronic device, and a storage medium.

### BACKGROUND

Existing methods for generating a video description text generally include generating, by a generation model, a description text based on video frame features of an entire video. In the existing methods, the generation model cannot accurately perceive content and order of different events in the video, which easily leads to misdescription and poor text generation effect.

### SUMMARY

Embodiments of the present disclosure provide a text generation method and apparatus, an electronic device, and a storage medium, which can improve the text generation effect.

In a first aspect, an embodiment of the present disclosure provides a text generation method. The method includes:
extracting events from a video to be processed, and determining target video frames corresponding to the events;
extracting frame features of the target video frames, and determining event features based on the frame features;
concatenating the event features in an extraction order of corresponding events, to generate a prompt text; and
generating, by a first language model, a description text of the video to be processed based on the prompt text.

In a second aspect, an embodiment of the present disclosure further provides a text generation apparatus. The apparatus includes:
a video frame determination module, configured to extract events from a video to be processed, and determine target video frames corresponding to the events;
an event feature determination module, configured to extract frame features of the target video frames, and determine event features based on the frame features;
a prompt text generation module, configured to concatenate the event features in an extraction order of corresponding events, to generate a prompt text; and
a description text generation module, configured to generate, by a first language model, a description text of the video to be processed based on the prompt text.

In a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the text generation method described in any of the embodiments of the present disclosure.

According to a fourth aspect, an embodiment of the present disclosure further provides a storage medium containing computer-executable instructions that, when executed by a computer processor, are used to perform the text generation method described in any of the embodiments of the present disclosure.

In the technical solution of the embodiments of the present disclosure, the events are extracted from the video to be processed, and the target video frames corresponding to the events are determined; the frame features of the target video frames are extracted, and the event features are determined based on the frame features; the event features are concatenated in the extraction order of the corresponding events, to generate the prompt text; and the description text of the video to be processed is generated by the first language model based on the prompt text. By concatenating the event features in the extraction order of the corresponding events to obtain the prompt text, and inputting the prompt text into the first language model, the first language model can be enabled to perceive content and order of different events in the video, which can improve the text generation effect.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a text generation method according to an embodiment of the present disclosure;

FIG. 2 is a schematic block diagram of a text generation method according to an embodiment of the present disclosure;

FIGS. 3(a) and 3(b) are schematic diagrams of a prompt text in a text generation method according to an embodiment of the present disclosure;

FIG. 4 is a schematic block diagram of a text generation method according to an embodiment of the present disclosure;

FIG. 5 is a schematic diagram of the structure of a text generation apparatus according to an embodiment of the present disclosure; and

FIG. 6 is a schematic diagram of the structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that the data involved in the technical solutions (including, but not limited to, the data itself and the access to or use of the data) shall comply with the requirements of corresponding laws, regulations, and relevant provisions.

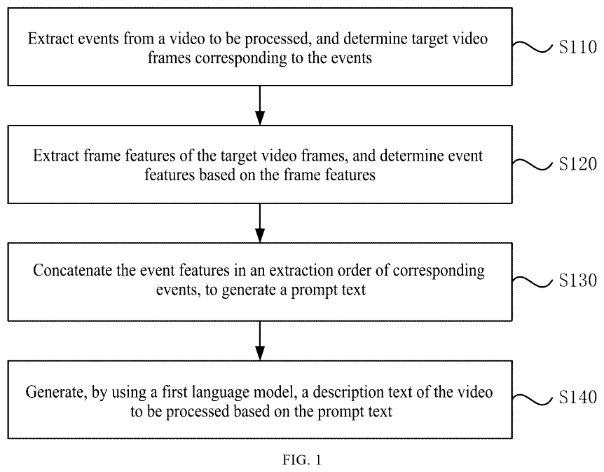

FIG. 1 is a schematic flowchart of a text generation method according to an embodiment of the present disclosure. This embodiment of the present disclosure is applicable to a case that a description text of a video is generated. The method may be performed by a text generation apparatus. The apparatus may be implemented in the form of software and/or hardware, and may be configured in an electronic device, for example, in a computer.

As shown in FIG. 1, the text generation method provided in this embodiment may include the following steps.

S110: extract events from a video to be processed, and determine target video frames corresponding to the events.

In this embodiment of the present disclosure, the video to be processed may be considered as a video for which a description text needs to be generated. For example, the video may be a long video or a short video. After the video to be processed is obtained, boundaries between different shots in the video to be processed may be detected based on an existing shot boundary detection algorithm, such as TransNet-V2; and shot segmentation may be performed based on the boundaries between the shots. Video frames of each shot obtained by segmentation may be considered to belong to different events, thereby completing the extraction of the events from the video to be processed.

Based on video frames belonging to a same event, target video frames corresponding to the event may be determined. For example, all video frames belonging to the same event may be used as target video frames of the event. For another example, video frames belonging to the same event may be sampled to obtain target video frames of the event, thereby saving computing resources to a certain extent and improving text generation efficiency.

Sampling the video frames belonging to the same event may be, for example, sampling, through uniform sampling, the target video frames from the video frames belonging to the same event, or sampling the target video frames from the video frames belonging to the same event based on quality parameters (such as brightness) of the video frames. In addition, other methods of sampling to obtain the target video frames may be also applicable here, which are not limited herein.

The number of target video frames corresponding to different events may be the same or different. The number of target video frames may be set according to actual application scenarios, so as to represent essential information of different events based on a relatively small number of target video frames. For example, it has been found through research that four target video frames may be extracted to represent each event, in order to balance the text generation effect and generation efficiency.

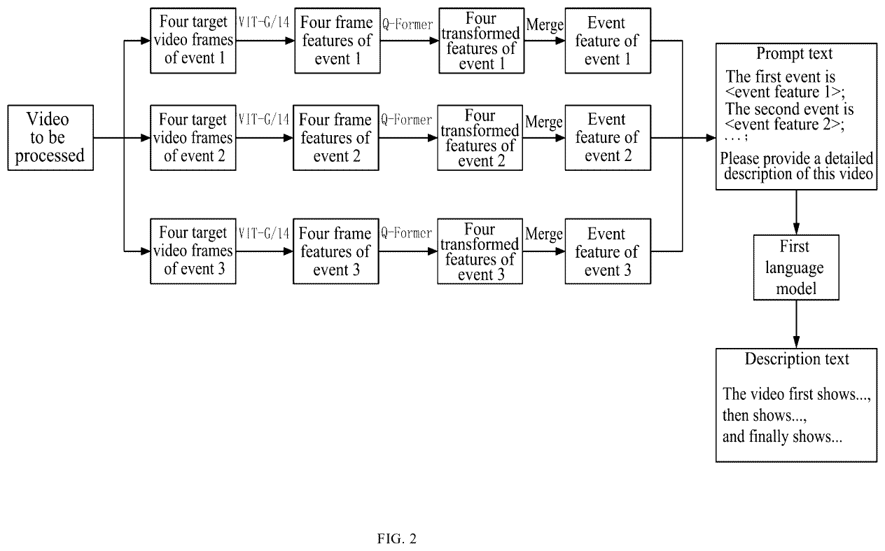

For example, FIG. 2 is a schematic block diagram of a text generation method according to an embodiment of the present disclosure. Referring to FIG. 2, three events may be extracted from the video to be processed, and four target video frames corresponding to each event may be determined.

S120: Extract frame features of the target video frames, and determine event features based on the frame features.

In this embodiment of the present disclosure, the frame features of the target video frames may be extracted based on an existing image feature extraction algorithm. For example, in FIG. 2, the frame features of the target video frames may be extracted based on a ViT-G/14 of a contrastive language-image pre-training (CLIP) model. In this case, an input target video frame may be transformed to an image of a size 3×224×224, where 3 may represent the number of channels of the image, and 224×224 may represent the width and the height of the image. Moreover, feature extraction may be performed on a target frame image to obtain an image with frame features of a size 256×1408.

Frame features of target video frames belonging to each event may be used to determine an event feature of the corresponding event. The event feature may be considered as a feature that can represent the essence of the event and can be decoded by a language model. Processing methods such as fusion and compression may be used to process the frame features corresponding to the same event, to obtain the event feature of the corresponding event.

In some optional implementations, determining event features based on the frame features may include: transforming the frame features into an input space of a first language model, to obtain transformed features: and determining the event features based on the transformed features.

The frame features may be transformed into the input space of the first language model based on an existing algorithm for transforming image features into text features, to obtain the transformed features, where the transformed features may be considered to belong to the text features. For example, in FIG. 2, a querying transformer (Q-Former) in a bootstrapping language-image pre-training with frozen image encoders and large language models (BLIP-2) may be used to transform the frame features into the text features. In this case, the frame features of a size 256×1408 may be compressed into transformed features of a size 32×768.

The Q-Former may be pre-trained to learn text-related visual representations, and to make the visual representations interpretable by the first language model, that is, an image feature extraction model with frozen parameters, and the first language model may be effectively utilized to transform the image features into the text features. In addition, other multimodal transformer algorithms may alternatively be used to transform the frame features into the text features, which is not specifically limited herein.

Referring again to FIG. 2, transformed features corresponding to an event may be combined in any combining manner to obtain an event feature of the event. For example, in some implementations, determining the event feature based on the transformed features may include at least one of: concatenating the transformed features, to obtain the event feature; or interactively compressing the transformed features, to obtain the event features. Any concatenating manner may be used to concatenate the transformed features to obtain the event feature. For example, a head-to-tail concatenating manner may be used to concatenate the transformed features to obtain the event features. An existing interactive compression manner may be used. For example, a transformer algorithm may be used to interactively compress the transformed features.

In these optional implementations, the event features are determined based on the frame features by first compressing the frame features into the text features and then combining the text features. In addition, the event features may alternatively be determined by first combining the frame features and then compressing.

S130: Concatenate the event features in an extraction order of corresponding events, to generate a prompt text.

In this embodiment of the present disclosure, the event features may be concatenated in sequence in a temporal order of extraction of the corresponding events, to generate the prompt text. It may be considered that the prompt text contains both event features that represent content of different events and a concatenating order that represents an occurrence order of the different events.

In some optional implementations, concatenating the event features in an extraction order of corresponding events may include: concatenating the event features in the extraction order of the corresponding events based on predefined order prompts and generation instruction prompts.

Different order prompts may be preset as concatenating connectives that represent boundaries and the order of the events. Any prompt that can indicate a boundary and order of an event may be set as an order prompt. For example, the order prompts in FIG. 2 may include “The first event is <>; The second event is <>; . . . ;” etc.

The generation instruction prompts may further be preset to indicate to the first language model the end of the prompt text. Any prompt that can be used as a generation instruction may be set as a generation instruction prompt. For example, in FIG. 2, the generation instruction prompt may include “Please provide a detailed description of this video”, etc.

The concatenating the event features in the extraction order of the corresponding events based on predefined order prompts and generation instruction prompts may include: concatenating the event features after corresponding order prompts in the extraction order of the events, to generate an event order prompt text; and concatenating the generation instruction prompts after the event order prompt text, to generate a prompt text.

The extraction order of the events may include the order of “first, second . . . ”, and the order prompts may also represent the order of “first, second . . . ”. That is, it may be considered that there is a correspondence between the extraction order of the events and the order prompts. The event features corresponding to the extraction order may be concatenated after the order prompts based on the correspondence, to obtain the event order prompt text. Refer to FIG. 2, in which “The first event is <event feature 1>; The second event is <event feature 2>; . . . ;” is the event order prompt text. Referring again to FIG. 2, the generation instruction prompt “Please provide a detailed description of this video” may be concatenated after the event order prompt text, to obtain a final prompt text.

In these optional implementations, the prompt text that can represent the content and order of the events may be generated based on the predefined order prompts and generation instruction prompts.

S140: Generate, by a first language model, a description text of the video to be processed based on the prompt text.

The first language model may include an existing pre-trained language model capable of generating a text based on a text, such as a VicunaV0-7B model. By inputting the prompt text into the first language model, the first language model can be caused to output the description text that may represent the order of the events in the video to be processed. For example, the description text generated in FIG. 2 is, for example, “The video first shows . . . , then shows . . . , and finally shows . . . ” to describe three events in the video to be processed.

In the technical solution of this embodiment of the present disclosure, the events are extracted from the video to be processed, and the target video frames corresponding to the events are determined; the frame features of the target video frames are extracted, and the event features are determined based on the frame features; the event features are concatenated in the extraction order of the corresponding events, to generate the prompt text; and the description text of the video to be processed is generated by the first language model based on the prompt text. By concatenating the event features in the extraction order of the corresponding events to obtain the prompt text, and inputting the prompt text into the first language model, the first language model can be enabled to perceive content and order of different events in the video, which can improve the text generation effect.

This embodiment of the present disclosure may be combined with various optional solutions in the text generation method provided in the above embodiments. The text generation method provided in this embodiment describes in detail a generation process of the prompt text. By adding speech texts and/or audio features of the video to be processed to the prompt text, generated content of the description text can be further enriched, and the generation quality of the description text can be improved.

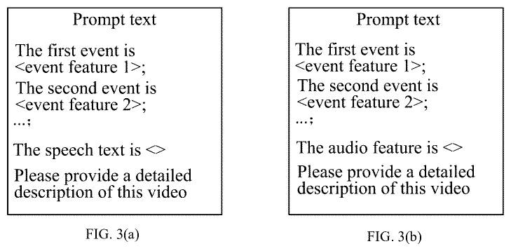

FIGS. 3(a) and 3(b) are schematic diagrams of a prompt text in a text generation method according to an embodiment of the present disclosure. It may be considered that the prompt text in FIGS. 3(a) and 3(b) are a supplement to that of FIG. 2, and details of its generation which are not described in detail may be found in the parts related to FIG. 2.

In this embodiment of the present disclosure, in a case that the video to be processed contains audio data, the text generation method may further include: performing speech recognition on the audio data, to obtain a speech text. Accordingly, generating a prompt text may further include: concatenating the concatenated event features with the speech text, to generate a prompt text.

The speech recognition may be performed on the audio data of the video to be processed based on an existing automatic speech recognition (ASR) algorithm, to obtain the speech text. The concatenated event features may be considered to include the event order prompt text in FIG. 2. As shown in FIG. 3(a), based on the speech text prompt “The speech text is <>”, the speech text may be concatenated after the event order prompt text and before the generation instruction prompt. Therefore, the generated description text contains a description corresponding to audio in addition to a description corresponding to vision, which can further enrich the content of the description text and improve the generation effect of the description text. By using the speech text as content of the prompt text, the first language model can directly generate the description text using content of the speech text, which can reduce, to a certain extent, the time spent in generating the description text.

In this embodiment of the present disclosure, in a case that the video to be processed contains audio data, the text generation method may further include: performing feature extraction on the audio data, to obtain an audio feature. Accordingly, the generating a prompt text further includes: concatenating the concatenated event features with the audio feature, to generate a prompt text.

Initial feature extraction may be performed on the audio data of the video to be processed based on an existing audio feature extraction algorithm. The extracted initial features may be transformed into the input space of the first language model, to obtain the audio feature. The concatenated event features may be considered to include the event order prompt text in FIG. 2. As shown in FIG. 3(b), based on an audio feature prompt “The audio feature is <>”, the audio feature may be concatenated after the event order prompt text and before the generation instruction prompt. Therefore, the generated description text contains a description corresponding to audio in addition to a description corresponding to vision, which can improve the generation effect of the description text. In addition, compared with the prompt text generated by concatenating the event features with the speech text, the prompt text obtained in this way may be simplified to a certain extent.

The technical solution of this embodiment of the present disclosure describes in detail the generation process of the prompt text. By adding the speech text and/or audio features of the video to be processed to the prompt text, generated content of the description text can be further enriched, and the generation quality of the description text can be improved. The text generation method provided in this embodiment of the present disclosure and the text generation method provided in the above embodiments belong to the same concept of disclosure. For the technical details not described in detail in this embodiment, reference may be made to the above embodiments, and the same technical features have the same beneficial effects in this embodiment and the above embodiments.

This embodiment of the present disclosure may be combined with various optional solutions in the text generation method provided in the above embodiments. The text generation method provided in this embodiment describes in detail the application scenarios of the generated video description text. In a scenario of video question answering, after a description text of a video is generated once, in response to a plurality of questions, a plurality of answer texts may be generated based only on the description text with no need to repeatedly process features of the video, which can save computational costs and improve answering efficiency. In addition, in a process of answer text generation, since both the description text and the answer text are in text modality, the advantages of single-modal fusion may be fully utilized to improve the accuracy of the answer, thereby avoiding the problem of low accuracy caused by poor fusion of multi-modal features when video modality features are introduced.

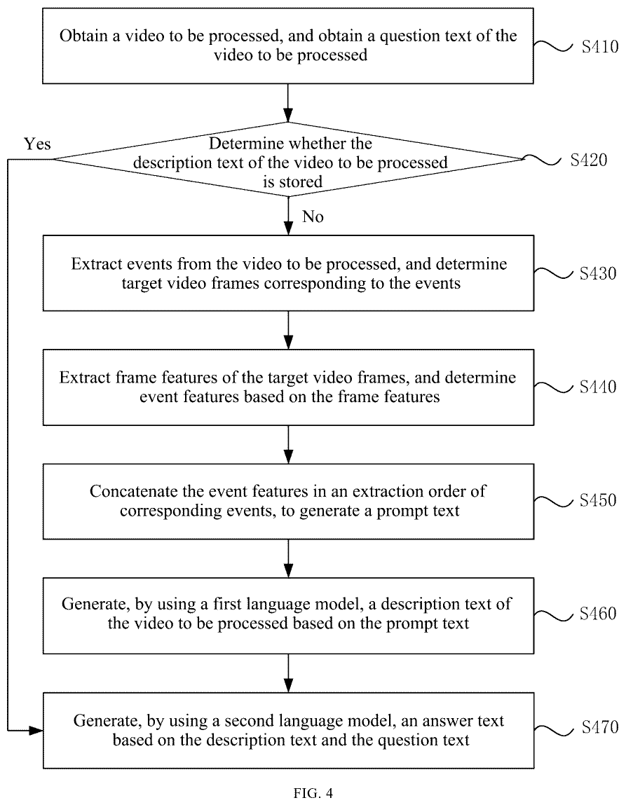

FIG. 4 is a schematic block diagram of a text generation method according to an embodiment of the present disclosure. As shown in FIG. 4, the text generation method provided in this embodiment may include the following steps.

S410: Obtain a video to be processed, and obtain a question text of the video to be processed.

In this embodiment, the question text may include, for example, entity extraction and entity relationship extraction from the video.

S420: Determine whether the description text of the video to be processed is stored. If the description text of the video to be processed is stored, the method goes to S470; if the description text of the video to be processed is not stored, the method goes to S430.

In this embodiment, the description text has not been generated during the first answering process, and in this case, it may be considered that no description text to be processed is stored, and the description text may be generated through steps S430 to S460. If it is not the first time to answer a question, it may be considered that the description text has been generated and stored, and in this case, the description text may be directly obtained for an answering step. After a description text of a video is generated once, in response to a plurality of questions, a plurality of answer texts may be generated based only on the description text with no need to repeatedly process features of the video, which can save computational costs and improve answering efficiency.

S430: Extract events from the video to be processed, and determine target video frames corresponding to the events.

S440: Extract frame features of the target video frames, and determine event features based on the frame features.

S450: Concatenate the event features in an extraction order of corresponding events, to generate a prompt text.

S460: Generate, by a first language model, a description text of the video to be processed based on the prompt text.

S470: Generate, by a second language model, an answer text based on the description text and the question text.

In this embodiment of the present disclosure, the second language model may be considered as a pre-trained language model capable of generating one text based on two texts. By inputting the description text and the question text into the second language model, the second language model can determine, in the description text, the answer text corresponding to the question text.

The technical solution of this embodiment of the present disclosure describes in detail the application scenarios of the generated video description text. In a video question answering scenario, after a description text of a video is generated once, in response to a plurality of questions, a plurality of answer texts may be generated based only on the description text with no need to repeatedly process features of the video, which can save computational costs and improve answering efficiency. In addition, in a process of answer text generation, since both the description text and the answer text are in text modality, the advantages of single-modal fusion may be fully utilized to improve the accuracy of the answer, thereby avoiding the problem of low accuracy caused by poor fusion of multi-modal features when video modality features are introduced.

In addition, the text generation method provided in this embodiment of the present disclosure and the text generation method provided in the above embodiments belong to the same concept of disclosure. For the technical details not described in detail in this embodiment, reference may be made to the above embodiments, and the same technical features have the same beneficial effects in this embodiment and the above embodiments.

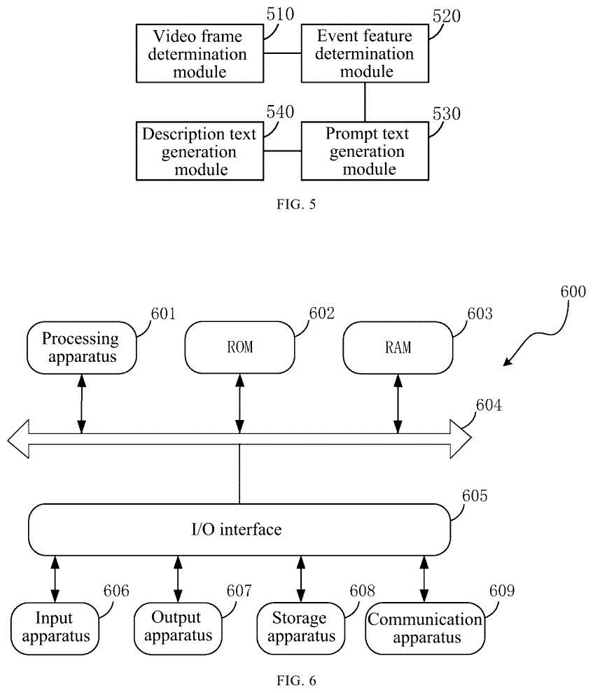

FIG. 5 is a schematic diagram of the structure of a text generation apparatus according to an embodiment of the present disclosure. The text generation apparatus provided in this embodiment is applicable to a case that a description text of a video is generated.

As shown in FIG. 5, the text generation apparatus provided in this embodiment of the present disclosure may include:
a video frame determination module 510 configured to extract events from a video to be processed, and determine target video frames corresponding to the events;
an event feature determination module 520 configured to extract frame features of the target video frames, and determine event features based on the frame features;
a prompt text generation module 530 configured to concatenate the event features in an extraction order of corresponding events, to generate a prompt text; and
a description text generation module 540 configured to generate, by a first language model, a description text of the video to be processed based on the prompt text.

In some optional implementations, the event feature determination module may be configured to: transform the frame features into an input space of the first language model, to obtain transformed features; and
determine the event features based on the transformed features.

In some optional implementations, the event feature determination module may be configured to perform at least one of:
concatenating the transformed features, to obtain the event features; and
interactively compressing the transformed features, to obtain the event features.

In some optional implementations, the prompt text generation module may be configured to:
concatenate the event features in an extraction order of corresponding events based on predefined order prompts and generation instruction prompts.

In some optional implementations, the prompt text generation module may be configured to:
concatenate the event features after corresponding order prompts according to the extraction order of the events, to generate an event order prompt text; and
concatenate the generation instruction prompts after the event order prompt text, to generate a prompt text.

In some optional implementations, in a case that the video to be processed contains audio data, the text generation apparatus may further include:
a speech recognition module configured to perform speech recognition on the audio data, to obtain a speech text.

Accordingly; the prompt text generation module may further be configured to: concatenate the concatenated event features with the speech text, to generate the prompt text.

In some optional implementations, in a case that the video to be processed contains audio data, the text generation apparatus may further include:
an audio feature determination module configured to perform feature extraction on the audio data, to obtain an audio feature.

Accordingly, the prompt text generation module may further be configured to: concatenate the concatenated event features with the audio feature, to generate the prompt text.

In some optional implementations, the text generation apparatus may further include a question answering module, where:
the question answering module may be configured to obtain a question text of the video to be processed after the description text is generated; and generate, by a second language model, an answer text based on the description text and the question text.

The text generation apparatus provided in this embodiment of the present disclosure can perform the text generation method provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

Reference is made to FIG. 6 below, which is a schematic diagram of the structure of an electronic device (such as a terminal device or a server in FIG. 6) 600 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processing unit, a graphics processing unit, etc.) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the text generation method of the embodiments of the present disclosure are performed.

The electronic device provided in this embodiment of the present disclosure and the text generation methods provided in the above embodiments belong to the same concept of disclosure. For the technical details not described in detail in this embodiment, reference may be made to the above embodiments, and this embodiment and the above embodiments have the same beneficial effects.

This embodiment of the present disclosure provides a computer storage medium having stored thereon a computer program that, when executed by a processor, causes the text generation methods provided in the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electric connection with one or more wires, a portable computer disk, a hard disk, a random access memory (RAM), a read-only memory (ROM), an erasable programmable read-only memory (EPROM) or a flash memory (FLASH), an optical fiber, a portable compact disc read-only memory (CD-ROM), an optical storage device, a magnetic storage device, or any appropriate combination of the above. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
extract events from a video to be processed, and determine target video frames corresponding to the events; extract frame features of the target video frames, and determine event features based on the frame features; concatenate the event features in an extraction order of corresponding events, to generate a prompt text; and generate, by a first language model, a description text of the video to be processed based on the prompt text.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The names of the units and the modules do not constitute a limitation on the units and the modules themselves under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), application-specific standard parts (ASSPs), a system on chip (SOC), a complex programmable logic device (CPLD), etc.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, a text generation method is provided. The method includes:
extracting events from a video to be processed, and determining target video frames corresponding to the events;
extracting frame features of the target video frames, and determining event features based on the frame features;
concatenating the event features in an extraction order of corresponding events, to generate a prompt text; and
generating, by a first language model, a description text of the video to be processed based on the prompt text.

According to one or more embodiments of the present disclosure, the text generation method is provided. The method further includes the following.

In some optional implementations, determining the event features based on the frame features includes:
transforming the frame features into an input space of the first language model, to obtain transformed features; and
determining the event features based on the transformed features.

According to one or more embodiments of the present disclosure, the text generation method is provided. The method further includes the following.

In some optional implementations, determining the event features based on the transformed features includes at least one of:
concatenating the transformed features, to obtain the event features; and
interactively compressing the transformed features, to obtain the event features.

According to one or more embodiments of the present disclosure, the text generation method is provided. The method further includes the following.

In some optional implementations, concatenating the event features in an extraction order of corresponding events includes:
concatenating the event features in the extraction order of the corresponding events based on predefined order prompts and generation instruction prompts.

According to one or more embodiments of the present disclosure, the text generation method is provided. The method further includes the following.

In some optional implementations, concatenating the event features in the extraction order of the corresponding events based on the predefined order prompts and the generation instruction prompts includes:
concatenating the event features after corresponding order prompts according to the extraction order of the events, to generate an event order prompt text; and
concatenating the generation instruction prompts after the event order prompt text, to generate a prompt text.

According to one or more embodiments of the present disclosure, the text generation method is provided. The method further includes the following.

In some optional implementations, in a case that the video to be processed contains audio data, the method further includes:
performing speech recognition on the audio data, to obtain a speech text.

Accordingly, generating the prompt text further includes: concatenating the concatenated event features with the speech text, to generate the prompt text.

According to one or more embodiments of the present disclosure, the text generation method is provided. The method further includes the following.

In some optional implementations, in a case that the video to be processed contains audio data, the method further includes:
performing feature extraction on the audio data, to obtain an audio feature.

Accordingly, generating the prompt text further includes: concatenating the concatenated event features with the audio feature, to generate the prompt text.

According to one or more embodiments of the present disclosure, the text generation method is provided. The method further includes the following.

In some optional implementations, after the generation of the description text, the method further includes:
obtaining a question text of the video to be processed; and
generating, by a second language model, an answer text based on the description text and the question text.

According to one or more embodiments of the present disclosure, a text generation apparatus is provided. The apparatus includes:
a video frame determination module configured to extract events from a video to be processed, and determine target video frames corresponding to the events;
an event feature determination module configured to extract frame features of the target video frames, and determine event features based on the frame features;
a prompt text generation module configured to concatenate the event features in an extraction order of corresponding events, to generate a prompt text; and
a description text generation module configured to generate, by a first language model, a description text of the video to be processed based on the prompt text.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/we claim:

1. A text generation method, comprising:
extracting events from a video to be processed, and determining target video frames corresponding to the events;
extracting frame features of the target video frames, and determining event features based on the frame features;
concatenating the event features in an extraction order of corresponding events, to generate a prompt text; and
generating, by a first language model, a description text of the video to be processed based on the prompt text.

2. The method according to claim 1, wherein determining the event features based on the frame features comprises:
transforming the frame features into an input space of the first language model, to obtain transformed features; and
determining the event features based on the transformed features.

3. The method according to claim 2, wherein determining the event features based on the transformed features comprises at least one of:
concatenating the transformed features, to obtain the event features; or
interactively compressing the transformed features, to obtain the event features.

4. The method according to claim 1, wherein concatenating the event features in the extraction order of the corresponding events comprises:
concatenating the event features in the extraction order of the corresponding events based on predefined order prompts and generation instruction prompts.

5. The method according to claim 4, wherein concatenating the event features in the extraction order of the corresponding events based on the predefined order prompts and the generation instruction prompts comprises:
concatenating the event features after corresponding order prompts according to the extraction order of the events, to generate an event order prompt text; and
concatenating the generation instruction prompts after the event order prompt text, to generate the prompt text.

6. The method according to claim 1, wherein in response to the video to be processed containing audio data, the method further comprises:
performing speech recognition on the audio data, to obtain a speech text; and
accordingly, generating the prompt text further comprises: concatenating the concatenated event features with the speech text, to generate the prompt text.

7. The method according to claim 1, wherein in response to the video to be processed containing audio data, the method further comprises:
performing feature extraction on the audio data, to obtain an audio feature; and
accordingly, generating the prompt text further comprises: concatenating the concatenated event features with the audio feature, to generate the prompt text.

8. The method according to claim 1, wherein after the description text is generated, the method further comprises:
obtaining a question text of the video to be processed; and
generating, by a second language model, an answer text based on the description text and the question text.

9. An electronic device, comprising:
one or more processors; and
a storage apparatus configured to store one or more programs, wherein
the one or more programs, when executed by the one or more processors, cause the one or more processors to:
extract events from a video to be processed, and determine target video frames corresponding to the events;
extract frame features of the target video frames, and determine event features based on the frame features;
concatenate the event features in an extraction order of corresponding events, to generate a prompt text; and
generate, by a first language model, a description text of the video to be processed based on the prompt text.

10. The electronic device according to claim 9, wherein the one or more programs, when causing the one or more processors to determine the event features based on the frame features, cause the one or more processors to:
transform the frame features into an input space of the first language model, to obtain transformed features; and
determine the event features based on the transformed features.

11. The electronic device according to claim 10, wherein the one or more programs, when causing the one or more processors to determine the event features based on the transformed features, cause the one or more processors to perform at least one of:
concatenate the transformed features, to obtain the event features; or
interactively compress the transformed features, to obtain the event features.

12. The electronic device according to claim 9, wherein the one or more programs, when causing the one or more processors to concatenate the event features in the extraction order of the corresponding events, cause the one or more processors to:
concatenate the event features in the extraction order of the corresponding events based on predefined order prompts and generation instruction prompts.

13. The electronic device according to claim 12, wherein the one or more programs, when causing the one or more processors to concatenate the event features in the extraction order of the corresponding events based on the predefined order prompts and the generation instruction prompts, cause the one or more processors to:
concatenate the event features after corresponding order prompts according to the extraction order of the events, to generate an event order prompt text; and
concatenate the generation instruction prompts after the event order prompt text, to generate the prompt text.

14. The electronic device according to claim 9, wherein in a case that the video to be processed contains audio data, the one or more programs, when executed by the one or more processors, further cause the one or more processors to:
perform speech recognition on the audio data, to obtain a speech text; and
accordingly, the one or more programs, when causing the one or more processors to generate the prompt text, further cause the one or more processors to: concatenate the concatenated event features with the speech text, to generate the prompt text.

15. The electronic device according to claim 9, wherein in a cast that the video to be processed contains audio data, the one or more programs, when executed by the one or more processors, further cause the one or more processors to:
perform feature extraction on the audio data, to obtain an audio feature; and
accordingly, the one or more programs, when causing the one or more processors to generate the prompt text, further cause the one or more processors to: concatenate the concatenated event features with the audio feature, to generate the prompt text.

16. The electronic device according to claim 9, wherein the one or more programs, when executed by the one or more processors and after the description text is generated, further cause the one or more processors to:
obtain a question text of the video to be processed; and
generate, by a second language model, an answer text based on the description text and the question text.

17. A non-transitory storage medium containing computer-executable instructions, wherein the computer-executable instructions, when executed by a computer processor, cause the computer processor to:
extract events from a video to be processed, and determine target video frames corresponding to the events;
extract frame features of the target video frames, and determine event features based on the frame features;
concatenate the event features in an extraction order of corresponding events, to generate a prompt text; and
generate, by a first language model, a description text of the video to be processed based on the prompt text.

18. The non-transitory storage medium according to claim 17, wherein the computer-executable instructions, when causing the computer processor to determine the event features based on the frame features, cause the computer processor to:
transform the frame features into an input space of the first language model, to obtain transformed features; and
determine the event features based on the transformed features.

19. The non-transitory storage medium according to claim 18, wherein the computer-executable instructions, when causing the computer processor to determine the event features based on the transformed features, cause the computer processor to perform at least one of:
concatenate the transformed features, to obtain the event features; or
interactively compress the transformed features, to obtain the event features.

20. The non-transitory storage medium according to claim 17, wherein the computer-executable instructions, when causing the computer processor to concatenate the event features in the extraction order of the corresponding events, cause the computer processor to:
concatenate the event features in the extraction order of the corresponding events based on predefined order prompts and generation instruction prompts.
